(19) United States
(12) Patent Application Publication
(10) Pub. No.: US 2026/0371050 A1
(43) Pub. Date: Nov. 19, 2026

(54) MULTIPLE HOST STACKS WITH SINGLE BLUETOOTH CONTROLLER

(71) Applicant: QUALCOMM Incorporated, San Diego, CA (US)

(72) Inventors: Tony GOGOI, San Diego, CA (US); Anubhav GUPTA, Hyderabad (IN); Yanhui GUO, Shanghai (CN)

(21) Appl. No.: 19/155,385

(22) PCT Filed: Mar. 4, 2023
(86) PCT No.: PCT/CN2023/079701

§ 371 Date: Aug. 11, 2025

(51) Int. Cl. H04W 4/80; H04W 76/15; H04W 92/22

(52) U.S. Cl. CPC H04W 4/80; H04W 76/15; H04W 92/22

(57) ABSTRACT

The embodiments include systems and methods for communicating over multiple host controller interfaces (HCIs) on a wireless device that includes a plurality of Bluetooth (BT) host-stacks. The wireless device may assign a host identifier (hostID) to each BT host-stack on the device and notify another wireless device that the wireless device includes multiple BT host-stacks. The wireless device includes the hostID of a BT host-stack in a packet header of a data packet of a Tx message, and sends the Tx message to the second wireless device. In response to receiving an Rx message from the other wireless device, the wireless device may identify a BT host-stack or an HCI interface that is associated with a hostID included in the received Rx message. The wireless device may forward the Rx message to the BT host-stack on the HCI interface associated with the destination hostID.

### BACKGROUND

Low power wireless devices, such as wearable devices, have grown in popularity and use. These devices may include a processor running a High-Level Operating System (HLOS) and one or more subsystems and/or co-processors. The HLOS may be responsible for running the primary applications and user interface of the device, and the subsystems and co-processors may be responsible for running lower-level tasks such as sensor data processing and communication protocols.

Bluetooth is a communication protocol that is widely used for wireless communication between devices, including wearable devices. Yet, running a full-fledged Bluetooth stack on the HLOS may consume a significant amount of power in the low power wireless device. To reduce power consumption, many wireless devices now use a hybrid approach in which the HLOS runs a Bluetooth stack in high power mode with a rich user experience (UX) and one or more subsystems and/or co-processors run a Bluetooth stack with limited capability in low power mode.

### SUMMARY

Various aspects include methods of communicating over multiple host controller interfaces (HCIs) on a first wireless device that includes a plurality of Bluetooth (BT) host-stacks. Various aspect methods may include assigning a host identifier (hostID) to each BT host-stack in the plurality of BT host-stacks, notifying a second wireless device that the first wireless device includes the plurality of BT host-stacks, which may include the hostID of a BT host-stack in a packet header of a data packet of a transmit (Tx) message, and sending the Tx message to the second wireless device.

Some aspects may further include receiving a receive (Rx) message from the second wireless device, identifying a BT host-stack in the plurality of BT host-stacks or an HCI interface associated with a destination hostID included in the packet header of the received Rx message, and forwarding the received Rx message to the BT host-stack on the HCI interface associated with the destination hostID.

Some aspects may further include identifying an application-instance based on peer-id, source hostID, or remote hostID, and sending the Rx message from the BT host-stack to a client application associated with the identified application-instance.

Some aspects may further include registering to receive generic attribute profile (GATT) notifications by writing the hostID to a server characteristic of a GATT server on the second wireless device.

Some aspects may further include receiving a GATT notification from the GATT server on the second wireless device, identifying a BT host-stack in the plurality of BT host-stacks or an HCI interface associated with a destination hostID included in the received GATT notification, and forwarding received the GATT notification to the BT host-stack on the HCI interface associated with the destination hostID.

Some aspects may include in the packet header of the data packet a value that identifies a processing unit of the first wireless device that includes the BT host-stack. Some aspects may include in the packet header of the data packet a value that identifies an application-specific integrated circuit (ASIC), a digital signal processor (DSP), an audio digital signal processor (ADSP), or a microcontroller unit (MCU) that operates at a lower frequency than an application processor of the first wireless device.

In some aspects, including the hostID of the BT host-stack in the packet header of the data packet may include which may include the hostID in a logical link control and adaptation protocol (L2CAP) a protocol data unit (PDU).

In some aspects, including the hostID in the L2CAP PDU may include generating a 16-bit L2CAP value that includes a source hostID and a destination hostID in most significant 4 bits of a L2CAP channel ID (L2CID) in the least significant 12 bits of the L2CAP.

Some aspects may further include storing a mapping of application-instance_id, peer-id, and remote hostID, Some aspects may further include identifying a destination host ID based on an application-instance.

Further aspects may include a computing device (e.g., first or second wireless device) having a processor configured with processor-executable instructions to perform various operations corresponding to the methods discussed above.

Further aspects may include a computing device having various means for performing functions corresponding to the method operations discussed above.

Further aspects may include a non-transitory processor-readable storage medium having stored thereon processor-executable instructions configured to cause a processor to perform various operations corresponding to the method operations discussed above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 is a system block diagram illustrating an example communication system suitable for implementing any of the various embodiments.

FIGS. 2 and 3 are a component block diagrams illustrating example computing devices suitable for implementing any of the various embodiments.

FIG. 4 is a component block diagram illustrating an example BT/Bluetooth Low Energy (BLE) system architecture according to some embodiments.

FIGS. 5A-5D are process flow diagrams that illustrate methods of communicating over multiple host controller interfaces (HCIs) on a wireless device that includes a plurality of Bluetooth (BT) host-stacks in accordance with some embodiments.

FIG. 6A is a process flow diagram that illustrates a method of using the generic attribute profile (GATT) protocol to communicate over multiple HCIs on a wireless device that includes a plurality of Bluetooth host-stacks in accordance with some embodiments.

FIG. 6B is a process flow diagram that illustrates a method of registering to send GATT notifications to a wireless device that includes a plurality of Bluetooth host-stacks in accordance with some embodiments.

FIG. 6C is a process flow diagram that illustrates a method of using the GATT protocol to communicate over multiple HCIs on a wireless device that includes a plurality of Bluetooth host-stacks in accordance with another embodiment.

FIGS. 6D and 6E are process flow diagrams that illustrate methods of registering and receiving GATT notifications in accordance with some embodiments.

FIG. 7 is a process flow diagram that illustrates a method of communicating over multiple host controller interfaces (HCIs) on a wireless device that includes a plurality of Bluetooth (BT) host-stacks in accordance with some embodiments.

FIG. 8 is a component block diagram illustrating an example computing device suitable for use with the various embodiments.

FIG. 9 is a component block diagram illustrating an example wireless communication device suitable for use with the various embodiments.

FIG. 10 illustrates an example wearable computing device in the form of a smart watch according to some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

In overview, the various embodiments include methods, and computing devices configured to implement the methods, for allowing a Bluetooth controller to support multiple Bluetooth hosts on a wireless device over multiple host controller interfaces (HCIs). Since all Bluetooth host-stacks may share the same device-address, the Bluetooth controller may include and use a host ID in a packet header to differentiate between different Bluetooth hosts on the same wireless device.

An increased number of wireless-capable devices are being developed that require or support high-performance operations. As a result of implementing increasingly complex processors, power consumption within these devices has increased. Increased power consumption is especially problematic in smaller devices, such as wearable devices that are battery-powered, including smart watches, virtual reality (VR) goggles, smart glasses, and medical devices that typically utilize small-profile rechargeable batteries due to physical design constraints. Such devices often utilize Bluetooth (BT) and/or BT Low Energy (BLE) to convey information with another paired device. Advertising and scanning for devices and establishing and maintaining a BT/BLE connection may further increase power consumption within a given device.

Wireless devices (e.g., wearable devices, etc.) often have limited battery resources, and running a full Bluetooth stack on the main high-level operating system (HLOS) of a wireless device may consume a significant amount of power or battery resources of the wireless device and/or otherwise have a negative impact on the user experience. To conserve power and maintain basic Bluetooth functionality, many wireless devices use a hybrid approach in which the HLOS runs a full Bluetooth stack with a rich user experience and one or more subsystems or co-processors run a more limited Bluetooth stack in low power mode. In low power mode, the wireless device may suspend the processor running the HLOS and continue to run Bluetooth protocols on its subsystems or co-processors. Yet, the implementation of this hybrid approach may present various technical challenges. For example, using the hybrid approach, it may be challenging to associate incoming traffic with the correct Bluetooth host when there are multiple Bluetooth host-stacks included in the same device (and thus share the same address).

Some embodiments may overcome these technical challenges by using an IP-based solution, such as network address translation (NAT) and/or a Hyper Text Transport Protocol (HTTP) proxy, to establish point-to-point connections and assign unique addresses to the endpoints. Yet, such IP-based solutions may not be suitable for platforms that include more than one Bluetooth host on each device. In addition, these IP-based solutions could introduce additional latency in the Bluetooth communications (e.g., due to the HTTP proxy acting as a middleman, etc.), may require adding additional processing capabilities to the Bluetooth controller, and/or may otherwise have a negative impact on the power consumption characteristics of Bluetooth controller or wireless device.

In some embodiments, the wireless device may be equipped with a Bluetooth controller that is configured to overcome these and other technical challenges to support multiple Bluetooth hosts over multiple host controller interfaces (HCIs). By supporting multiple Bluetooth hosts over multiple HCIs, the Bluetooth controller may operate as a hub with multiple simultaneous connections to multiple Bluetooth-enabled components and/or devices without adding additional processing complexity to the Bluetooth controller. That is, the embodiments may allow multiple components to connect to a Bluetooth controller (i.e., hub) at the same time and share data or other resources without consuming an excessive amount of the device's power or processing resources.

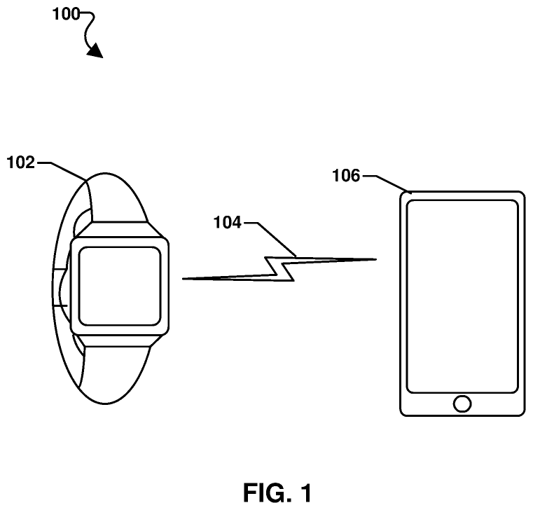

The Bluetooth controller may be configured to operate at a low frequency and/or low power mode to implement the Bluetooth controller stack, support multiple hosts, use a serialized approach for requests and responses on a per-device basis, maintain a single logical link control and adaptation protocol (L2CAP) channel for radio frequency communication (RFCOMM) and/or generic attribute profile (GATT) to the other devices, improve the efficiency of packet forwarding and other Bluetooth operations within the device, and maintain compliance with existing and future Bluetooth standards, all without consuming an excessive amount of the device's power or processing resources. As discussed in more detail below with reference to FIG. 1, in some embodiments, RFCOMM may be used for serial communication over Bluetooth and GATT may be used to organize and transfer data over a Bluetooth low energy (BLE) connection.

In some embodiments, the Bluetooth controller may be configured to advertise or negotiate the capability to support multiple Bluetooth hosts between two peer Bluetooth devices. The advertisements or capability negotiations may indicate that one or more of the devices may support multiple Bluetooth hosts. The Bluetooth controller may use unique identifiers to identify each of the different Bluetooth host-stacks on each peer device. That is, the Bluetooth controller may achieve host-protocol-to-host-protocol uniqueness by using unique identifiers to identify different Bluetooth host-stacks on each peer device.

In some embodiments, the Bluetooth controller may be configured to define a unique Bluetooth host identifier (hostId) for each Bluetooth host in a wireless device, and include the hostId in a header (e.g., as packet header information in a PDU, etc.) so that it may be readily accessed by the Bluetooth controller. The hostId may be a value that identifies the different entities (e.g., the default Bluetooth host running on the HLOS, another Bluetooth host running on a digital signal processor (DSP) or microcontroller unit (MCU), etc.) that handle the Bluetooth communication in the wireless device. For example, a hostId of zero (0) may identify the default Bluetooth host running on the HLOS, a hostId of one (1) may identify the Bluetooth host running on an audio digital signal processor (ADSP) of the device, a hostId of two (2) may identify the Bluetooth host running on the microcontroller unit (MCU), etc.

In some embodiments, the Bluetooth controller may be configured to include the hostId and a connection identifier (connId) or device address in an enhanced logical link control and adaptation protocol (L2CAP) Channel ID (L2CID). A L2CID may be a unique 16 bit identifier assigned to a specific communication channel between two Bluetooth devices that allows the devices to identify and communicate with each other over a particular channel. In some embodiments, the Bluetooth controller may generate an enhanced L2CID that reserves a certain number of bits (X bits) in the L2CID package for the hostId. For example, the Bluetooth controller may reserve the most significant bits of the L2CID for the source and destination hostIds. In some embodiments, the Bluetooth controller may generate the enhanced L2CID by performing leftward shifting or using the following pseudocode: L2CID (source_host_id<<14)|(destination_host_id<<10), where source_host_id and destination host_id are 2 bits each that identify the source and destination host stacks respectively. In above pseudocode, the source_host_id is leftward shifted 14 bits and the destination host id is leftward shifted 10 bits. As a result, the 4 most significant bits of the enhanced L2CID identify the source and destination host stacks, and the 12 least significant bits include the L2CID. Including the hostId in the enhanced L2CID may improve the scalability and flexibility of Bluetooth communications without introducing compatibility issues or requiring changes in the existing L2CAP layer implementations.

As an example, in response to receiving an Tx message request, a Bluetooth controller on a multi host-stack device may add the host ID into the source_host_id field of the L2CAP protocol data unit (PDU) and send it to the associated peer Bluetooth device. In response to receiving an Rx message from the associated peer Bluetooth device, the Bluetooth controller may examine the L2CAP header of the Rx message, extract a destination_host_id from the L2CID of the L2CAP, use the extracted destination_host_id to determine the destination Bluetooth host-stack within the device, and forward the L2CAP message on the host controller interface (HCI) associated with the destination host_id so that the L2CAP PDU message is received on the Bluetooth host-stack of the processor associated with the message. In some embodiments, the Bluetooth controller generate a service data unit (SDU) based on the L2CAP PDU, and send the SDU to the Bluetooth host-stack of the processor associated with the message. The SDU may include the payload of the L2CAP PDU.

As another example, in response to receiving an Rx message from a multi host-stack device (associated peer Bluetooth device), a Bluetooth controller on a single host-stack device may determine the hostId (source_host_id) of the component from which the message is received, and use a combination hostId and an HCI connection handle (HCI-connection-handle) to identify the peer host-stack on the multi host-stack device (associated peer Bluetooth device). In response to receiving an Tx message request, the Bluetooth controller on a single host-stack device may use the combination of the HCI connection handle, source_host_id (which may be an empty, null, or zero value in this case because it includes only one host), destination_host_id, and RFCOMM data link connection identifier (DLCI) to identify a unique channel over which to communicate with the multi host-stack device (associated peer Bluetooth device). The DLCI is discussed in more detail below (e.g., with reference to FIG. 1, etc.).

In some embodiments, the Bluetooth controller may be configured to register for GATT communications. GATT transactions are discussed in more detail below with reference to FIG. 1. Briefly, conventional GATT communications require that only one GATT request be sent from a device at a time. As such, Bluetooth controllers in devices that include multiple Bluetooth hosts could be required to coordinate and/or synchronize the GATT transactions so that only one Bluetooth host sends a GATT request at a time and/or so that no additional GATT requests are sent until a GATT response is received. However, implementing such coordination and/or synchronization functionality in a Bluetooth controller may require adding additional functionality (e.g., handshaking, etc.) and/or additional processing capabilities to the Bluetooth controller or may otherwise reduce the power consumption characteristics of Bluetooth controller or wireless device.

In some embodiments, the Bluetooth controller may be configured to use a connection identifier (connId) or device address in the Bluetooth protocol stack to ensure that the correct connection is used for data transfer and synchronization across GATT transactions. In some embodiments, the connId may be used to identify the unique combination of an HCIConnectionId and a hostId in the context of the RFCOMM protocol and/or the GATT protocol. For example, the Bluetooth controller may generate the connId to include HCIConnectionId, destination host_id, and the source_host_id.

In some embodiments, the Bluetooth controller may be configured to use the HCIConnectionId and the hostId as a unique GATT client-server pair to achieve GATT client-server uniqueness with respect to asynchronous connection-less (ACL) data. As a result, the Bluetooth controller may perform synchronization across GATT transactions, such as requests and responses (REQ/RSP), on a per [connld+hostId] basis (e.g., instead of [connId] or device address only), thereby avoiding synchronization requirements across the multiple Bluetooth host-stacks in the wireless device. As a result, the Bluetooth controller may perform GATT transactions for multiple Bluetooth hosts on the device without added processing capabilities and/or while operating in a low power consumption mode.

As an example, when a GATT client on a multi-host device wants to receive notifications on another characteristic GATT client, the GATT client may register to receive GATT notifications by writing to the server characteristic, such as the control-point characteristic. In some embodiments, as part of the GATT registration process, the Bluetooth controller may send the source_host_id to GATT server. The GATT server on the peer device may register the HCI-connection-handle and the source_host_id as a unique GATT-protocol endpoint so that all GATT notifications PDUs associated with the characteristic are sent on the notification characteristic with a destination host_id value set. The destination_host_id value may be the source_host_id value received from the GATT client. When a GATT notification is received on the multi-host device, the Bluetooth controller may determine the hostId from the destination host id in the GATT notification, send the GATT notification to the BT host-stack associated with the hostId for delivery to the correct GATT client.

By using a combination of the HCI connection handle, source_host_id, and destination_host_id as a unique identifier, the various embodiments may use the GATT protocol stack to manage multiple GATT connections at the same time. Only GATT transactions within unique-host-stack to unique-host-stack need to be sequential, thus and multiple GATT transactions may be performed simultaneously across different unique-host-stacks on the same device without the multiple GATT connections interfering with each other.

FIG. 1 is a system block diagram illustrating an example communication 100 system suitable for implementing any of the various embodiments. The communication system 100 may be a short-range communications network including multiple devices capable of wireless communication. For example, the communication system 100 may be a Bluetooth (BT) communication system including a first BT device 102 and second BT device 106.

Bluetooth is a wireless technology and communication protocol that enables wireless devices to communicate with one another in a short-range environment. The communications between the devices (e.g., first BT device 102 and second BT device 106) may be based on a layered architecture in which each layer provides different services to an upper layer. One such layer is the logical link control and adaptation protocol (L2CAP) layer, which is a data link layer responsible for managing the logical connections between Bluetooth devices. L2CAP channels, which may be identified by unique channel IDs (CIDs), may be used to establish a logical connection between the two Bluetooth devices 102, 106 so that they may send and receive data. L2CAP may also be used for segmentation and reassembly of data, quality of service (QoS) control, and to support multiple channels. While L2CAP provides a flexible and powerful way to establish connections between Bluetooth devices, it does not provide adequate support for multiplexing the data that is sent over the Bluetooth connections.

Radio frequency communication (RFCOMM) is a Bluetooth protocol that supports multiplexing the data that is sent over L2CAP channels. RFCOMM may include a serial-like communication service that creates a virtual serial port on Bluetooth-enabled devices that allows them to communicate with other Bluetooth devices as if they were connected via a serial cable. For example, RFCOMM may be used to create a serial port profile (SPP) on a device that allows it to communicate with other devices that support SPP. In some embodiments, RFCOMM may be used for serial communication using Bluetooth.

Generic attribute profile (GATT) is a Bluetooth protocol that enables two Bluetooth devices to communicate data using “services” and “characteristics.” A “service” may be a collection of data and functionality offered by a device. A “characteristic” may be a unit of data or functionality offered as part of a service. When a device connects to another device, it may use the GATT protocol to discover the available services and characteristics, and exchange data with the connected device by reading or writing the values of the characteristics. The GATT protocol may also be used to handle security, authentication, and authorization. In some embodiments, GATT may be used to organize and transfer data over a Bluetooth low energy (BLE) connection.

Each of the devices (e.g., first BT device 102 and second BT device 106) may include a Bluetooth host controller, which may be a hardware and/or software component that manages the communication between Bluetooth components or devices. The Bluetooth host controller may be responsible for managing the device's Bluetooth radio and/or implementing the Bluetooth protocol stack.

Each of the devices (e.g., first BT device 102 and second BT device 106) may implement host-controller-cooperating (HCC) system that divides the Bluetooth protocol stack into two parts: a host stack that runs on the high-level operating system (HLOS) and a controller stack that runs on a processor. The host stack may be responsible for high-level tasks (e.g., connection management, etc.) and the controller stack may be responsible for lower-level tasks (e.g., packet forwarding, scheduling, etc.). HCC may allow a single Bluetooth host controller to manage multiple link layers or controller instances. HCC may also allow multiple Bluetooth radios to operate independently within the same Bluetooth host controller instance. Each Bluetooth host controller instance may have its own set of connections and operate independently of the other host controller instances. HCC is particularly useful in multi-radio systems because it may enable the host to assign different attributes (e.g., power, QoS, etc.) to different host controller instances and interact with different controller instances.

In some embodiments, the devices (e.g., first BT device 102 and second BT device 106) include, implement or use a host controller interface (HCI), which is a Bluetooth interface that enables communications between a host and a controller (e.g., the radio) of a Bluetooth device. HCI may allow a host controller instance to control the radio's operations (e.g., sending and receiving data, etc.). For example, HCI may include a set of commands and events that the host controller instance may use to control and/or communicate with the radio. The HCI may be implemented as a layer between the host and the controller.

In some embodiments, the devices (e.g., first BT device 102 and second BT device 106) include, implement or use a data link connection identifier (DLCI). A DLCI may be an identification value (e.g., a 16-bit value, etc.) that may be used to identify a logical link between two devices. That is, a logical link may be generated to establish communication between the devices (e.g., first BT device 102 and second BT device 106), and each logical link may be assigned a DLCI. The DLCI may be used in the L2CAP protocol layer to, for example, multiplex and demultiplex different logical links and/or to allow for multiple devices to be connected over the same physical link while ensuring that data is sent to the correct device. The logical links may be synchronous connection oriented (SCO) links or asynchronous connectionless (ACL) links.

Asynchronous connection-less (ACL) links are data communication links used in Bluetooth to send data between devices without a continuous connection. The data may be sent in packets such that devices do not need to be continuously connected for the data transfer to take place. That is, unlike other forms of communications (e.g., SCO) that require a continuous connection, ACL may allow the devices 102, 106 to be connected only when sending and receiving data. As a result, the devices 102, 106 may conserve power and use the radio more efficiently by only turning it on when necessary. Each packet of data sent over an ACL connection may contain both the data and information about how the data should be handled, such as error checking and retransmission. This packet structure also allows for more efficient use of the radio bandwidth by allowing multiple devices to share the same radio channel.

In some embodiments, the Bluetooth controller on one or more of the devices (e.g., first BT device 102 and second BT device 106) may be configured to establish an L2CAP channel for RFCOMM on the main stack running the HLOS, and to send the L2CAP data and information context to the host-stacks running on a low power processor (e.g., MCU, ADSP, DSP, etc.).

In some embodiments, the Bluetooth controller may be configured to use a single L2CAP channel RFCOMM on a device-to-device basis with RFCOMM data link connection identifiers (DLCIs) identifying different RFCOMM channels. Each connected component may have a separate L2CAP channel and/or a separate RFCOMM channel for communication. The RFCOMM DLCIs may be used to identify the different RFCOMM channels that are in use by each of the connected components/devices.

In some embodiments, the Bluetooth controller may be configured to assign an HCIConnectionId to the connection between two devices when the connection is established. The HCIConnectionId may be used to identify the connection in subsequent communication between the devices.

The first BT device 102 may be any type of computing device capable of Bluetooth communications, such as a wearable device (e.g., smart watch, smart glasses, virtual reality systems, and medical devices such as heart monitors). The second BT device 106 may be any type of computing device capable of Bluetooth communications that is communicatively compatible with the first BT device 102.

The first BT device 102 may be communicatively coupled to the second BT device 106 via wireless connection 104, which may be a Bluetooth wireless connection. For ease of illustration, the communication system 100 includes one communicatively connected, or paired, BT device 106. However, more paired BT device 106 may be implemented within the communications system 100. For example, the first BT device 102 may be paired with multiple Bluetooth devices simultaneously including the second BT device 106 and additional Bluetooth devices of a same or different type (e.g., cellular phone, laptop computer, multimedia displays, other wearable device such as audio output devices, Point-of-Sale systems) that are capable of Bluetooth communications.

The wireless connection 104 may be a Bluetooth connection established via handshaking processes between the first BT device 102 and the second BT device 106. The first BT device 102 may transmit BT data to and receive BT data from the second BT device 106 according to the specific protocols and connection type of the wireless connection 104. As used herein, the term “BT data” may include data (e.g., data packets) received or transmitted across a Bluetooth (BT) or Bluetooth low energy (BLE) connection to an endpoint (e.g., BT application). BT data may also refer to any information used to establish and maintain BT connections and to communicate data packets through various layers of a BT stack (e.g., BT controller, Host, applications) of a processor, such as packet header information, Software In Band Sleep (SIB) information, system integrity information such as number of completed packets (NoCP), service discovery protocol (SDP) information, packet identifiers, attribute handles, connection handles, and channel identifiers associated with BT data packets.

The first BT device 102 may function in various Bluetooth modes as defined by Bluetooth Core Specification v5.3. For example, the first BT device 102 may function and perform operations in an active mode (i.e., high-performance mode) or a low power mode (i.e., sleep mode, low-performance mode). The first BT device 102 may include two or more processors, which may be utilized depending on the mode of operation. For example, the first BT device 102 may include a low power processor that may perform BLE functions during a low power mode, and an application processor (i.e., performance processor) that may perform functions alongside the low power processor during an active mode. Thus, the first BT device 102 may conserve battery life by when in a low power mode by utilizing only the low power processor, and may perform Bluetooth operations when in an active mode by utilizing the application processor.

Various embodiments may also be implemented on a number of single processor and multiprocessor computer systems, including a system-on-chip (SoC) or system in a package (SIP).

A system-on-chip (SoC) may be a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SoCs may also include software for controlling the integrated resources and processors, as well as for controlling peripheral devices.

A SIP may be a single module or package that contains multiple resources, computational units, cores and/or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SoCs coupled together via high-speed communication circuitry and packaged in close proximity, such as on a single motherboard or in a single computing device. The proximity of the SoCs facilitates high speed communications and the sharing of memory and resources.

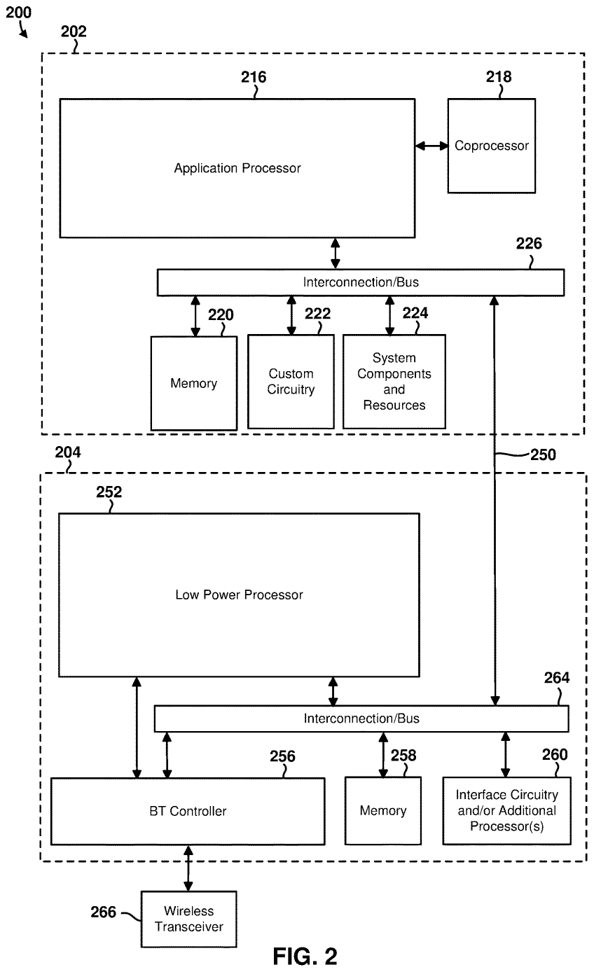

FIG. 2 is a component block diagram illustrating an example computing device 200 in the form of a SoC or SIP that is suitable for implementing any of the various embodiments. The computing device 200 may be included in a wearable device or Bluetooth-capable device (e.g., first BT device 102, second BT device 106).

With reference to FIGS. 1 and 2, the illustrated example computing device 200 includes first circuitry 202 (e.g., low power mode circuitry and components) communicably coupled to second circuitry 204 (e.g., active mode circuitry and components). The first circuitry 202 may include components that operate as a processing unit of the computing device 200 that carries out the instructions of software application programs by performing the arithmetic, logical, control and input/output (I/O) operations specified by the instructions. In some embodiments, the second circuitry 204 may include components that operate as a processing unit for managing Bluetooth operations during a low power mode of operation and during transitions between a low power mode and an active mode in which the first circuitry 202 is activated.

The first circuitry 202 may include an application processor (AP) 216, one or more coprocessors 218 (e.g., vector co-processor) connected to one or more of the processors, memory 220, custom circuity 222, system components and resources 224, and an interconnection/bus module 226. The second circuitry 204 may include a low power processor 252, an interconnection/bus module 264, a Bluetooth controller 256, memory 258, and interface circuitry and/or various additional processors 260, such as a packet processor. The Bluetooth controller 256 may be communicably coupled to a wireless transceiver 266, and may be configured to transmit and receive Bluetooth data to and from the wireless transceiver 266. The wireless transceiver 266 may be configured to transmit and receive wireless communications (e.g., Bluetooth messages including BT data and context information) via an antenna (not shown) to/from wireless computing devices, such as a Bluetooth-capable wireless device (e.g., second BT device 106).

Each processor 216, 218, 252, 260 may include one or more cores, and each processor/core may perform operations independent of the other processors/cores. For example, the first circuitry 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 216, 218, 252, 260 may be included as part of a processor cluster architecture (e.g., a synchronous processor cluster architecture, an asynchronous or heterogeneous processor cluster architecture, etc.).

The first and second circuitries 202, 204 may include various system components, resources, and custom circuitry for managing sensor data, analog-to-digital conversions, wireless data transmissions, and for performing other specialized operations, such as decoding data packets and processing encoded audio and video signals for rendering in a web browser or audio/video application. For example, the system components and resources 224 of the first circuitry 202 may include power amplifiers, voltage regulators, oscillators, phase-locked loops, peripheral bridges, data controllers, memory controllers, system controllers, access ports, timers, and other similar components used to support the processors and software clients running on a computing device. The system components and resources 224 and/or custom circuitry 222 may also include circuitry to interface with peripheral devices, such as cameras, electronic displays, wireless communication devices, external memory chips, etc.

The first and second circuitries 202, 204 may communicate via interconnection/bus module 250. In some embodiments, the interconnection/bus module 250 may be a connection established by transceiving (i.e., receiving and transmitting) components within both the first circuitry 202 and second circuitry 204. For example, the low power processor 252 may include a universal asynchronous receiver-transmitter (UART) and the application processor 216 may include a multiple signal messages (MSM) UART driver that is communicatively connected to the UART of the low power processor 252.

The various processors 216, 218, may be interconnected to one or more memory elements 220, system components and resources 224, and custom circuitry 222 via an interconnection/bus module 226. Similarly, the low power processor 252 may be interconnected to the Bluetooth controller 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second circuitries 202, 204 may further include an input/output module (not illustrated) for communicating with resources external to the circuitries 202, 204, such as a clock, a voltage regulator, one or more wireless transceivers 266, and/or a subscriber identity module (SIM) and/or SIM interface (i.e., an interface for receiving one or more SIM cards). Resources external to the circuitries 202, 204 may be shared by two or more of the internal processors/cores.

The interface circuitry and/or additional processors 260 may be configured to perform various operations for arbitrating GATT packets in a dual Bluetooth stack configuration, in which the low power processor 252 implements a first Bluetooth stack and the application processor 216 implements a second Bluetooth stack. In some embodiments, the interface circuitry and/or additional processors 260 may include the Bluetooth controller 256 and all functions thereof, in which the interface circuitry and/or additional processors 260 is configured to transceive Bluetooth data with the wireless transceiver 256 and the Bluetooth stacks of the low power processor 252 and the application processor 216. In some embodiments, the interface circuitry and/or additional processors 260 may be configured to implement an arbitration layer for routing Bluetooth data between the Bluetooth stacks and the wireless transceiver 266. In some embodiments, the interface circuitry and/or additional processors 260 may include the interconnection/bus modules 226, 250, 264 for routing Bluetooth data between the Bluetooth stacks and the Bluetooth controller 256 (i.e., in embodiments in which the Bluetooth controller 256 is not a component of the interface circuitry and/or additional processors 260) or wireless transceiver 266 (i.e., in embodiments in which the Bluetooth controller 256 is a component of the interface circuitry and/or additional processors 260). In some embodiments, the interface circuitry and/or additional processors 260 may be included within the low power processor 252.

In addition to the example computing device 200 discussed above, various embodiments may be implemented in a wide variety of computing systems, which may include a single processor, multiple processors, multicore processors, or any combination thereof.

In some embodiments, the various processors of the first circuitry 202 and second circuitry 204 may be located within a same SoC. For example, the application processor 216 and low power processor 252 may be located within a same SoC, such as in a single SoC of a wearable device, to perform Bluetooth functions in both a low power mode (i.e., low power processor 252 is utilized) and an active mode (i.e., application processor is activated and utilized). As another example, a computing device, such as a wearable device (e.g., first BT device 102), may include one SoC including the first circuitry 202 and the second circuitry 204 to perform Bluetooth functions in both a low power mode and an active mode, in which the low power processor 252 is utilized during a low power mode, and the application processor 216 is activated and utilized during an active mode.

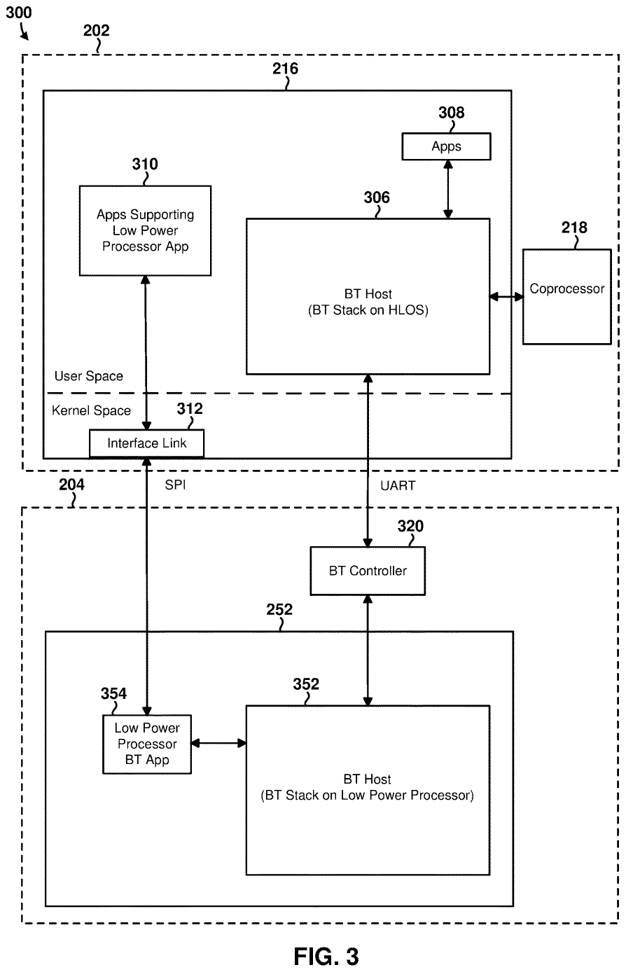

FIG. 3 is a component block diagram illustrating an example computing device 300 suitable for implementing some embodiments. In the example illustrated in FIG. 3, the computing device 300 includes first circuitry 202 that includes a high-speed application processor 216 and second circuitry 204 that includes a low-power processor 252.

The high-speed application processor 216 may include a Bluetooth host 306, applications 308, applications supporting a low power processor app 310, and an interface link 312. The low-power processor 252 may include a Bluetooth host 352 and low power Bluetooth apps 354. In some embodiments, the low-power processor 252 may be an application-specific integrated circuit (ASIC), DSP, audio digital signal processor (ADSP), or microcontroller unit (MCU) that operates at a lower frequency than the application processor 216.

In some embodiments, the Bluetooth host 306 may include or may be a Bluetooth stack on a high-level operating system (HLOS). In some embodiments, the Bluetooth host 352 may include or may be a Bluetooth stack on the low-power processor. In some embodiments, the computing device 300 may include other subsystems, such as a modem, that do not include their own Bluetooth stack.

The interface link 312 may facilitate communications between the application processor 312 and low-power processor 252. In some embodiments, the interface link 312 may also include a driver module that utilizes the Serial Peripheral Interface (SPI) cable to facilitate communications between the application processor 312 and the coprocessor 218. The driver module may package and send messages through the SPI cable and/or may interpret incoming messages from the cable, thereby improving the efficiency of the communications.

In some embodiments, the computing device 300 may include Bluetooth controller 320 that connects to the Bluetooth stack 306 on the high-speed application processor 216 and the Bluetooth stack 352 on the low-power processor 252. It should be noted that the example illustrated in FIG. 3 includes two host-stacks (e.g., 306, 352, etc.), but the coprocessor 218 could include a third host-stack in some embodiments. As such, it should be understood that the computing device 300 may include any number of Bluetooth host-stacks, and nothing in this application should be used to limit the claims to two host-stacks unless expressly recited as such in the claims.

In some embodiments, the Bluetooth controller 320 may be included on the same die or circuity as the low-power processor 252. In some embodiments, the application processor 216 and the coprocessor 218 may be included on the same die or circuitry 202. In some embodiments, the coprocessor 218 may be an ADSP processor that operates in parallel with the application processor 216. In some embodiments, the coprocessor 218 (e.g., ADSP, etc.) may be configured to continue to use the Bluetooth stack 306 and communicate with the Bluetooth controller 320 even if the application processor 216 is turned off. Turning off the entire application processor 216, while continuing to operate the coprocessor 218 and other subsystems that are on the same die or circuity 202 may result in significant power savings.

In some embodiments, the computing device 300 may include or implement a Direct Feedback (DFB) interconnection architecture as part of the application subsystem (e.g., application processor 216, etc.). The DFB interconnects architecture may include functionality that is similar to the communication architecture that allows different processors (e.g., the application processor 216 and the low-power processor 252, etc.) to communicate with each other, but which allows processors that are on the same die to share more resources. The DFB interconnection architecture may allow for turning off the application processor 216 and continuing to independently operate the coprocessor 218 (e.g., ADSP, etc.) on the same die or circuity 202.

In some embodiments, the coprocessor 218 (e.g., ADSP, etc.) may be configured to operate in parallel with a modem subsystem (not illustrated in FIG. 3) of the computing device 300. In some embodiments, the coprocessor 218 may be configured to communicate with the application processor 216 via physical interconnects. In embodiments in which the application processor 216 and the coprocessor 218 are on the same die, they may be connected through a separate interface (e.g., SPI cable, etc.).

With reference to FIGS. 1-3, resource constrained wireless devices (e.g., a smartwatch, first BT device 102, etc.) may include an application processor 216 that runs at a high speed and another low-power processor 252 that runs at a low speed.

An important purpose of the low-power processor 252 and/or coprocessor 218 is to offload functionality from the application processor 216, allowing the high-speed application processor 216 to be turned off to save power. For example, in a smartwatch with a small battery, notification functionalities could be offloaded the low-power processor 252 to conserve energy. Yet, the display of notifications may be tightly coupled to the user interface (UI), which may use the Bluetooth stack 306 and/or may be controlled by the high-speed application processor 216. As a result, the high-speed application processor 216 may need to be turned on or activated every time a notification is received. This may have a negative impact on performance and power consumption characteristics of the device and/or otherwise negatively impact on the user experience.

Similarly, it is desirable for Bluetooth applications 308 to leverage a Bluetooth stack 352 running on the low-power processor 252 instead of relying on the Bluetooth stack 306 running on the high-speed application processor 216. For example, if the low-power processor 252 is not capable of supporting the notification functionally discussed above, the computing device 300 may use the application processor 216 for the notification functionality. However, if the low-power processor 252 has the capability and resources to perform the notification functionally discussed above, it should take over this responsibility and use its own Bluetooth stack 352, thereby reducing the power consumption on the computing device 300.

The system illustrated in FIG. 3 includes a single Bluetooth controller 320 that connects to multiple Bluetooth hosts 306, 352, thereby facilitating the offloading of Bluetooth-related functionally from high-speed application processor 216 to the low-power processor 252. Yet, the current Bluetooth specifications do not readily support a configuration in which the computing device 300 includes more than one Bluetooth host 306, 352. These limitations of the current Bluetooth specifications could be overcome by adding relatively robust functionality (e.g., handshaking functionality, etc.) to the Bluetooth controller 320. However, it is beneficial to configure the Bluetooth controller 320 to implement minimal functionality and consume very little power, such as only to communicate with the radio frequency (RF) component of the device 300. Accordingly, in some embodiments, the Bluetooth controller 320 may be configured to support multiple hosts (e.g., 306, 352, etc.) connected to a single controller (e.g., Bluetooth controller 320, etc.) while implementing minimal added functionality, operating in a low power mode, and complying with current and future Bluetooth specifications.

In some embodiments, the computing device 300 may be configured to use unique identifiers for the coprocessor 218 (e.g., ADSP, etc.), the application processor 202, and the low-power processor 252. For example, one identifier could be assigned to the application processor 202, another to the coprocessor 218, and a third to the low-power processor 252. The computing device 300 may use these unique identifiers to identify the different host stacks on each device and implement a serialized approach for requests and responses on a per-device basis.

In some embodiments, the computing device 300 may be configured to support multiple hosts over multiple host controller interfaces (HCIs), thereby operating as a Bluetooth hub with multiple simultaneous connections to multiple Bluetooth-enabled devices. For example, the Bluetooth controller 320 may configured to implement the Bluetooth controller stack, support multiple hosts, use a serialized approach for requests and responses on a per-device basis, and maintain a single L2CAP channel for RFCOMM and GATT. The Bluetooth controller 320 may include separate interfaces for both the application processor 202 and the low-power processor 252. The logical location of the Bluetooth controller 320 may vary, depending on the device and computing architecture. For example, the Bluetooth controller 320 may be a separate subsystem on the same die as the other processors, and communicate with the other processors through interfaces such as UART and IPC. As a further example, in a smartwatch, the Bluetooth controller 320 may be included in the same die as the low-power processor 252, and the application processor 202 may communicate with the Bluetooth controller 320 over a UART interface.

In some embodiments, the computing device 300 may be configured to efficiently direct RF packets to the correct Bluetooth hosts 306, 352 in a multi-host device configuration, while also addressing complications with the GATT protocol. The current specification for GATT may require a server and a client in which only one outstanding request-reply is allowed at a time. The computing device 300 may use a unique identifier for each Bluetooth host 306, 352, a device category advertisement and/or capability negotiation to allow for multiple host stacks and/or to eliminate the need for communication between the different Bluetooth host 306, 352 stacks on the device. This may improve power efficiency and reduce latency via improved communication efficiency.

In some embodiments, the Bluetooth controller 320 may be configured to negotiate the capability to support multiple Bluetooth hosts between two peer Bluetooth devices (e.g., first BT device 102 and second BT device 106 illustrated in FIG. 1). This may be achieved by using unique identifiers to identify different Bluetooth host-stacks on each peer device. That is, the Bluetooth controller 320 may achieve host-protocol-to-host-protocol uniqueness by using unique identifiers to identify different Bluetooth host-stacks on each peer device.

In some embodiments, the Bluetooth controller 320 may be configured to define a unique Bluetooth host identifier (hostId) for each Bluetooth host in a wireless device. The hostId may be a value that identifies the different entities (e.g., the default Bluetooth host running on the HLOS, another Bluetooth host running on a DSP or MCU, etc.) that handle the Bluetooth communication in the wireless device. For example, a hostId of zero (0) may identify the default Bluetooth host running on the HLOS, a hostId of one (1) may identify the Bluetooth host running on an audio digital signal processor (ADSP) of the device, a hostId of two (2) may identify the Bluetooth host running on the MCU, etc. In some embodiments, after the capability negotiations are complete, the wireless device may include the hostId in a header (e.g., as packet header information in a PDU, etc.) so that it may be readily accessed by the Bluetooth controller.

In some embodiments, the Bluetooth controller 320 may be configured to include the hostId in a L2CAP header, baseband header, or any other header accessible to the Bluetooth controller. In some embodiments, the Bluetooth controller 320 may be configured to generate or use an enhanced L2CID that includes the hostId. In some embodiments, the Bluetooth controller 320 may be configured to generate the enhanced L2CID by reserving a certain number of bits in the L2CID, which may be a 16 bit value. For example, the Bluetooth controller 320 may generate the enhanced L2CID by reserving a number of bits in the most significant bits of the L2CID for the hostId. In some embodiments, the Bluetooth controller 320 may generate the enhanced L2CID by using left-ward shifting or the following pseudocode: L2CID|(source_host_id<<14)|(destination_host_id<<10), where source_host_id and destination host_id are 2 bits each that identify the source and destination host stacks respectively. Including the hostId in the L2CID (e.g., in the most significant bits, etc.) may improve the scalability and flexibility of Bluetooth communications without introducing compatibility issues or requiring changes in the existing L2CAP layer implementations.

In some embodiments, the Bluetooth controller 320 may be configured to assign an HCIConnectionId to a connection between two devices. The HCIConnectionId may be assigned by the Bluetooth controller when the connection is established. The HCIConnectionId may be used to identify the connection in subsequent communication between the devices.

In some embodiments, the Bluetooth controller 320 may be configured to use a connection identifier (connId) in the Bluetooth protocol stack. For example, the Bluetooth controller 320 may be configured to use the connId to ensure that the correct connection is used for data transfer and synchronization across GATT transactions. In some embodiments, the connId may be used to identify the unique combination of an HCIConnectionId and a hostId in the context of the RFCOMM protocol and the GATT protocol.

In some embodiments, the Bluetooth controller 320 may be configured to use [connld+hostId] as a unique GATT client-server pair to achieve GATT client-server uniqueness with respect to ACL data. As a result, the Bluetooth controller may perform synchronization across GATT transactions, such as requests and responses (REQ/RSP), on a per [connId+hostId] basis (e.g., instead of [connId] only), thereby avoiding synchronization requirements across the stacks.

In some embodiments, the Bluetooth controller 320 may be configured to establish an L2CAP channel for RFCOMM on the main stack running the HLOS, and to send the L2CAP information context to the host-stacks running on a low power processor (e.g., MCU, DSP, etc.).

In some embodiments, the Bluetooth controller 320 may be configured to use a single L2CAP channel RFCOMM on a per-device basis, with RFCOMM DLCIs identifying different RFCOMM channels. Each connected device/component may have a separate L2CAP channel and a separate RFCOMM channel for communication. The RFCOMM DLCIs may be used to identify the different RFCOMM channels that are in use by the connected devices/components.

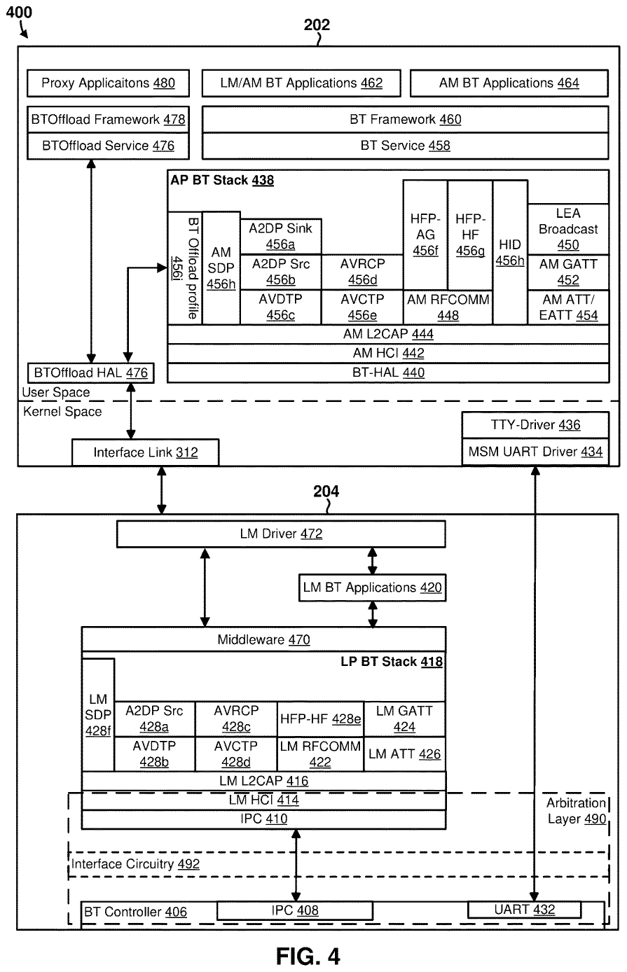

FIG. 4 is a component block diagram illustrating an example BT/BLE system architecture 400 including a stack configuration according to some embodiments. With reference to FIGS. 1-4, the BT/BLE system architecture 400 may be implemented on an first circuity 202 (e.g., application processor 216, application processor of additional processors 260) and second circuity 204 of a BT device (e.g., first BT device 102, computing device 200, 300, etc.). The first circuity 202 may include an application processor 216 that may be activated, or otherwise powered on or awoken, to perform BT-related operations during a BT active mode. During a BLE low power mode, or sleep mode, the application processor 216 may be deactivated, powered off, or may enter a sleep (low power) state, and the low-power processor 252 may perform BLE-related operations.

The application processor 216 may include an active mode (AM) application processor (AP) Bluetooth (BT) stack 438 (e.g., Fluoride, BlueZ, FreeBSD, Mac OS X, Microsoft BT stack, BlueCode+, etc.) that supports operations of low power mode (LM)/AM BT applications 462 that may be executed in both an LM and AM. The application processor may further support operations of AM BT applications 464 and proxy applications 480 that may be executed in an AM. The low-power processor 252 may include a low power BT stack 418 that supports operations of LM BT applications 420 that run solely during a LM. The application processor 216 may include BT Service 458 and BT Framework 460 to support LM/AM BT applications 462 and AM BT applications 464, and may further include BTOffload Service 476 and BTOffload Framework 478 to support the proxy applications 480. The BT framework 460 and BTOffload Framework 478 may be application code that may utilize BT application programming interfaces (APIs) to interact with BT hardware. The BT Service 458 may interface the BT Framework 460 with the AP BT stack 438, and the BTOffload Service 476 may interface the BTOffload Framework 478 with the AP BT stack 438.

The low-power processor 252 may include a BT controller 406 for interfacing and communicating with one or more paired BT devices (e.g., second BT device 106). The BT controller 406 may include a communication interface, such as an inter-process communication (IPC) module 408 and a universal asynchronous receiver-transmitter (UART) 432. The IPC module 408 may be configured to receive BT data (e.g., BT context information) from another BT device (e.g., second BT device 106) during an LM of the BT/BLE system architecture 400. The UART 432 may be configured to receive BT data (e.g., BT context information) from another BT device (e.g., second BT device 106). The LP BT stack 418 may include an IPC 410 for communicating BT data with the IPC module 408 of the BT controller 406 during either an LM or AM. The LP BT stack 418 may include an IPC 410 for communicating BT data with the IPC module 408 of the BT controller 406 during a LM.

The LP BT stack 418 may include any number of known BT profiles 428 or specifications that may define how BT data is transferred from one device (e.g., first BT device 102, system architecture 400) to another connected device (e.g., second BT device 106). The BT profiles 428 within the LP BT stack 418 may include, but are not limited to, profiles usable in LM, such as Advanced Audio Distribution Profile Source (A2DP Src) 428a, Audio/Video Distribution Transport Profile (AVDTP) 428b, Audio/Video Remote Control Profile (AVRCP) 428c, Audio/Video Control Transport Profile (AVCTP) 428d, Hands-Free Profile Hands-Free unit (HFP-HF) 428e, and LM Service Discovery Protocol (SDP) 428f. The LP BT stack 418 may further include an LM ATTribute (ATT) 426 protocol, an LM General ATT (GATT) 424, an LM RFCOMM (Radio frequency communication) 422, an LM L2CAP 416, and an LM Host Controller Interface (HCI) 414. The LM GATT 424 and LM L2CAP 416 may configure a wireless connection via the LM HCI 414 using one of the BT profiles 428. The LM RFCOMM 422 is a set of transport protocols made on top of the LM L2CAP 416 providing emulated RS-232 serial ports. The LM GATT 424 may define the way in which two BT devices (e.g., first BT device 102, second BT device 106) transfer BT data back and forth using Profiles (e.g., BT Profiles 428), Services, and Characteristics during a low power mode. The LM GATT 424 may utilize LM ATT 426 to store Profiles, Services, Characteristics, and other BT context information related to the functions and operation of the LM BT applications 420 during a low power mode of the system architecture 400. In other words, the LM GATT 424 may configure how BT data is transferred across the wireless connection based on the LM ATT 426.

The AP BT stack 438 may include any number of known BT profiles 456 or specifications that may define how BT data is transferred from one device (e.g., first BT device 102, system architecture 400) to another connected device (e.g., second BT device 106). The BT profiles 456 within the AP BT stack 438 may include, but are not limited to, profiles usable in both LM and AM, such as A2DP Src 456b, AVDTP 456c, AVRCP 456d, AVCTP 456e, HFP-HF 456g, and AM SDP 456h, and profiles usable in active mode only such as A2DP Sink 456a, Hands-Free Profile Audio Gateway (HFP-AG) 456f, Human Interface Device profile (HID) 456h, and BT Offload profile 456i.

The AP BT stack 438 may further include an AM ATT/enhanced ATT (EATT) 454 protocol, an AM GATT 452, an AM RFCOMM 448, an AM L2CAP 444, and an AM HCI 442. The AM GATT 452 and AM L2CAP 444 may configure a wireless connection via the AM HCI 442 using one of the BT profiles 456. The AM RFCOMM 448 is a set of transport protocols made on top of the AM L2CAP 444 providing emulated RS-232 serial ports. The AM GATT 452 may define the way in which two BT devices (e.g., first BT device 102, second BT device 106) transfer BT data back and forth using Profiles (e.g., BT Profiles 456), Services, and Characteristics during a low power mode. The AM GATT 452 may utilize AM ATT/EATT 454 to store Profiles, Services, Characteristics, and other BT context information related to the functions and operation of the LM/AM BT applications 462 and AM BT applications 464 during an active power mode of the system architecture 400. In other words, the AM GATT 452 may configure how BT data is transferred across the wireless connection based on the AM ATT/EATT 454.

The application processor 216 may include one or more drivers and/or interfaces to communicate BT data with the UART 432 of the BT controller 406. For example, the application processor 216 may include a kernel space that includes a multiple signal messages (MSM) UART driver 434 that is communicatively connected to the UART 432, and a teletypewriter (TTY)-driver 436 that is communicatively connected to the MSM UART driver 434. The AP BT stack 438 may include a BT-hardware abstraction layer (HAL) 440 that is configured to convey BT data with the TTY-driver and the AM HCI 442.

The low-power processor 252 may include middleware 470 that communicates BT data from the LP BT stack 418 to the LM BT applications during a LM, and to an LM driver 472 during an active mode. The LM driver 472 may communicate BT data to the application processor 216 via an Interface link 474. The Interface link 474 may be in a Kernel space of the application processor 216 and may communicate BT data to a BTOffload HAL 475 in user space of the application processor 216. The BTOffload HAL 475 may relay the BT data to the BTOffload Service 476 and/or the BT Offload profile 456i.

In embodiments implementing a Common Profile, such as GAP or DIS, the Common Profile may be implemented by the LP BT stack 418.

In some embodiments, the BT controller 406 may be implemented to arbitrate GATT packets in a dual BT stack configuration by interfacing between the LP BT stack 418, the AP BT stack 438, and a remote device (i.e., remote GATT client or remote GATT server). In some embodiments, a processor or circuitry implementing an arbitration layer 490 may be implemented to arbitrate GATT packets in a dual BT stack configuration by interfacing between the LP BT stack 418, the AP BT stack 438, and a remote device (i.e., remote GATT client or remote GATT server).

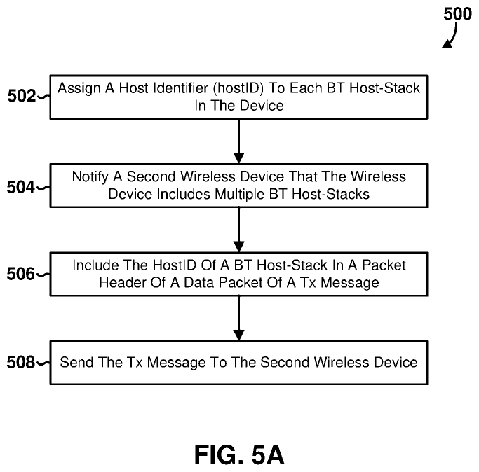

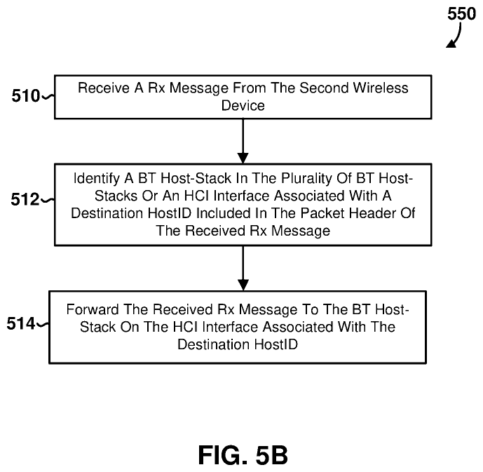

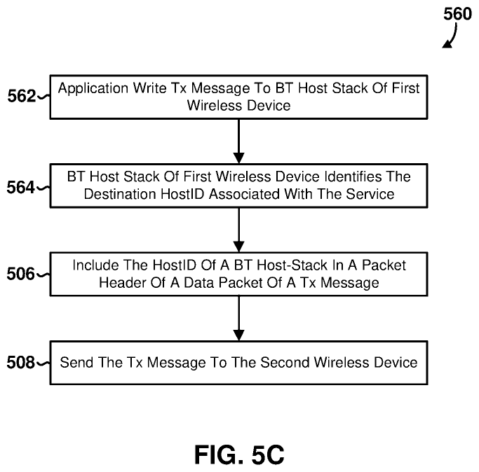

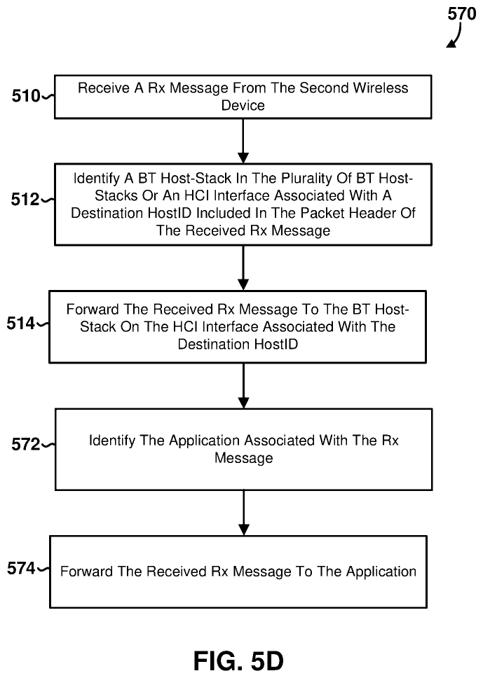

FIGS. 5A-5D illustrate methods 500, 550, 560, 570 of communicating over multiple host controller interfaces (HCIs) on a wireless device that includes a plurality of Bluetooth (BT) host-stacks in accordance with some embodiments. Methods 500, 550, 560, 570 may be performed by a controller (e.g., Bluetooth controller 320) or processor (e.g., application processor 216, etc.) in a first wireless device (e.g., first BT device 102, etc.) that communicates with second wireless device (i.e., other wireless devices).

With reference to FIGS. 1-5A, the controller may assign a host identifier (hostID) to each BT host-stack in the first wireless device in block 502. As discussed above, the controller may be configured to define a unique hostId for each Bluetooth host in a wireless device, and include the hostId in a header (e.g., as packet header information in a PDU, etc.) so that it may be readily accessed by the Bluetooth controller. The hostId may be a value that identifies the different entities (e.g., the default Bluetooth host running on the HLOS, another Bluetooth host running on a DSP or MCU, etc.) that handle the Bluetooth communication in the first wireless device. For example, a hostId of zero (0) may identify the default Bluetooth host running on the HLOS, a hostId of one (1) may identify the Bluetooth host running on an audio digital signal processor (ADSP) of the first wireless device, a hostId of two (2) may identify the Bluetooth host running on the microcontroller unit (MCU), etc.

In some embodiments, the controller or device may store and/or maintain a mapping of application-instance_id, peer-id, and remote hostID, In some embodiments, the controller or device may identify a destination host ID based on the application-instance or application-instance_id.

In block 504, the controller may notify a second wireless device (e.g., second BT device 106, etc.) that the first wireless device includes multiple BT host-stacks. That is, the controller may advertise or negotiate the capability to support multiple Bluetooth hosts between two peer Bluetooth devices. The advertisements or capability negotiations may indicate that one or more of the devices may support multiple Bluetooth hosts. The controller may use unique identifiers to identify each of the different Bluetooth host-stacks on each peer device. That is, the controller may achieve host-protocol-to-host-protocol uniqueness by using unique identifiers to identify different Bluetooth host-stacks on each peer device.

In block 506, the controller may include the hostID of a BT host-stack in a packet header of a data packet of a Tx message. The hostID may be a value that identifies a processing unit of the first wireless device. For example, the hostID may be a value that identifies an application-specific integrated circuit (ASIC), a digital signal processor (DSP), an audio digital signal processor (ADSP), or a microcontroller unit (MCU) that operates at a lower frequency than an application processor of the first wireless device. The hostID may also be a value that identifies the main applications processor of the first wireless device.

As discussed above, in some embodiments the controller may be configured to include the hostId and a connection identifier (connld) or device address in an enhanced L2CAP Channel ID (L2CID). A L2CID may be a unique 16 bit identifier assigned to a specific communication channel between two Bluetooth devices that allows the devices to identify and communicate with each other over a particular channel. In some embodiments, the Bluetooth controller may generate an enhanced L2CID that reserves a certain number of bits (X bits) in the L2CID package for the hostId. For example, the Bluetooth controller may reserve the most significant bits of the L2CID for the source and destination hostIds. In some embodiments, the Bluetooth controller may generate the enhanced L2CID by performing leftward shifting or using the following pseudocode: L2CID|(source_host_id<<14)|(destination_host_id<<10), where source_host_id and destination host id are 2 bits each that identify the source and destination host stacks respectively. In above pseudocode, the source_host_id is leftward shifted 14 bits and the destination_host_id is leftward shifted 10 bits. As a result, the 4 most significant bits of the enhanced L2CID identify the source and destination host stacks, and the 12 least significant bits include the L2CID. Including the hostId in the enhanced L2CID may improve the scalability and flexibility of Bluetooth communications without introducing compatibility issues or requiring changes in the existing L2CAP layer implementations.

In some embodiments, including the hostID of the BT host-stack in the packet header of the data packet in block 506 may include adding the hostID to logical link control and adaptation protocol (L2CAP) a protocol data unit (PDU). In some embodiments, including the hostID of the BT host-stack in the packet header of the data packet in block 506 may include generating a 16-bit L2CAP value that includes a source hostID and a destination hostID in most significant 4 bits of the L2CID and a L2CAP channel ID (L2CID) in the least significant 12 bits of the L2CAP.

In block 508, the controller may send the Tx message to the second wireless device. Thus, in response to receiving an Tx message request, the controller on a multi host-stack device may add the host ID into the source_host_id field of the L2CAP PDU and send a Tx message that includes the L2CAP PDU to the associated peer device.

In response to receiving the Tx message as an Rx message from the multi host-stack device, the controller second wireless device may determine the hostId (source_host_id) of the component from which the message is received, and use a combination hostId and an HCI connection handle (HCI-connection-handle) to identify the peer host-stack on the first wireless device to which communications are to be sent.

With reference to FIGS. 1-5B, the controller may receive an Rx message from the second wireless device in block 510. The controller on the second wireless device may use the combination of the HCI connection handle, source_host_id, destination host_id, and RFCOMM data link connection identifier (DLCI) to identify a unique channel over which to communicate with the first wireless device, and use the identified channel send the message (e.g., Rx message) to the first wireless device. In response to receiving the Rx message, the controller may examine the L2CAP header of the Rx message, extract a destination_host_id from the L2CID of the L2CAP, use the extracted destination host id to determine the destination Bluetooth host-stack within the first wireless device, and forward the L2CAP message on the HCI interface associated with the destination host id so that the L2CAP PDU message is received on the host-stack of the processor associated with the message.

In block 512, the controller may identify a BT host-stack in the plurality of BT host-stacks or an HCI interface associated with a destination hostID included in the packet header of the received Rx message. For example, the controller may read the destination hostID value in a L2CAP PDU of the received Rx message and query a reference table that associates the hostIDs with a corresponding processing unit, BT host-stack, HCI interface to determine the BT host-stack or the HCI interface that is associated with the destination hostID.

In block 514, the controller may forward the received Rx message to the BT host-stack on the HCI interface associated with the destination hostID. In some embodiments, the controller may generate a service data unit (SDU) based on the L2CAP PDU and send the SDU to the Bluetooth host-stack of the processor associated with the message in block 514. The SDU may include the payload of the L2CAP PDU. In some embodiments, the controller may identify an application-instance based on peer-id, source hostID, or remote hostID, and send the Rx message from BT host-stack to a client application associated with the identified application-instance.

With reference to FIGS. 1-5C, an application operating on the first wireless device may write a TX message to the BT host-stack of the first wireless device in block 562. The BT host-stack of the first wireless device may identify the destination HostID associated with a service requested by the application in block 564. In blocks 506 and 508, the controller may perform the operations discussed above with reference to FIG. 5A.

With reference to FIGS. 1-5D, the controller may perform the operations discussed above with reference to FIG. 5B in blocks 510-514. The controller may identify the application associated with the Rx message in block 572. The controller may forward the received Rx message to the identified application in block 574.

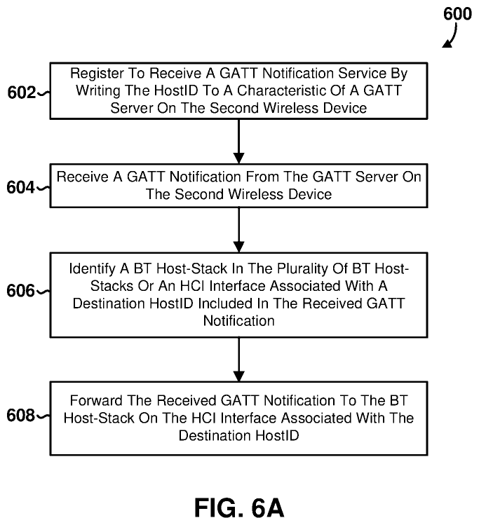

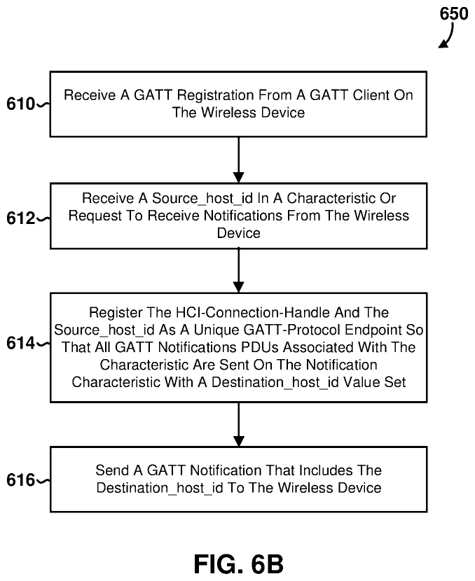

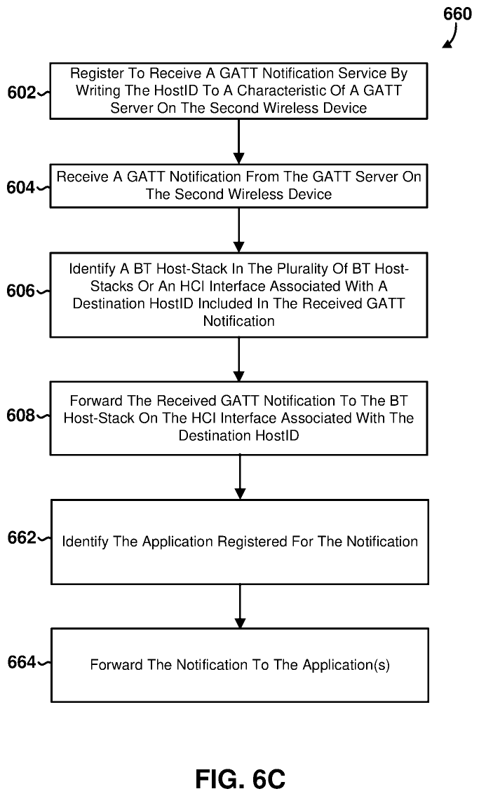

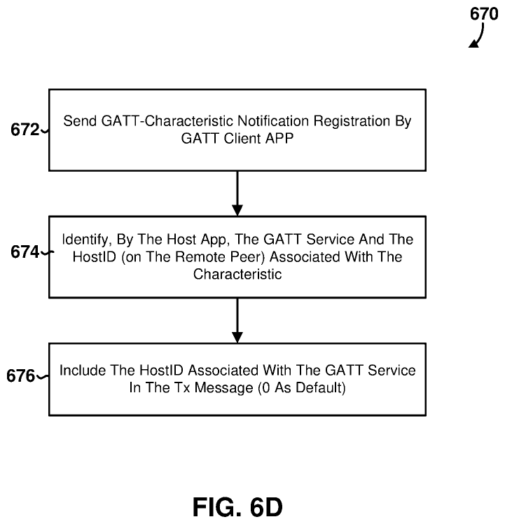

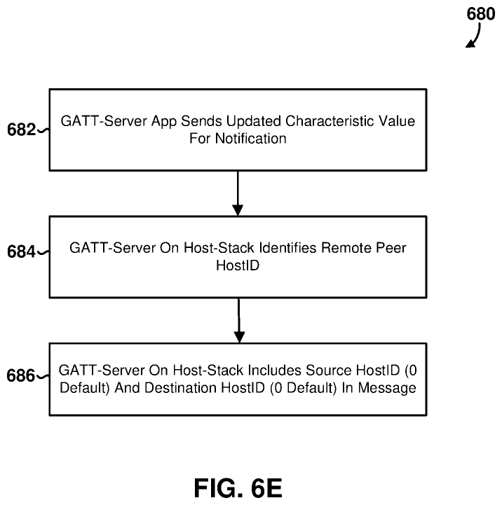

FIG. 6A illustrates a method 600 of using the generic attribute profile (GATT) protocol to communicate over multiple host controller interfaces (HCIs) on a wireless device that includes a plurality of Bluetooth (BT) host-stacks in accordance with some embodiments. Method 600 may be performed by a controller (e.g., Bluetooth controller 320) or processor (e.g., application processor 216, etc.) in a wireless device (e.g., first BT device 102, etc.).

With reference to FIGS. 1-6A, the controller may register to receive a GATT notification service by writing the hostID to a characteristic of a GATT server on the second wireless device in block 602. As discussed above, GATT is a Bluetooth protocol that enables two Bluetooth devices to communicate data using “services” and “characteristics.” A “service” may be a collection of data and functionality offered by a device. A “characteristic” may be a unit of data or functionality offered as part of a service. When a device connects to another device, it may use the GATT protocol to discover the available services and characteristics, and exchange data with the connected device by reading or writing the values of the characteristics.

In block 604, the controller may receive a GATT notification from the GATT server on the second wireless device. For example, the controller may read the value of a notification characteristic generated by the second wireless device.

In block 606, the controller may identify a BT host-stack in the plurality of BT host-stacks or an HCI interface associated with a destination hostID included in the received GATT notification. For example, the controller may read the destination hostID value in a notification characteristic generated by the second wireless device and query a reference table that associates the hostIDs with a corresponding processing unit, BT host-stack, HCI interface to determine the BT host-stack or the HCI interface that is associated with the destination hostID. In block 608, the controller may forward the received GATT notification to the BT host-stack on the HCI interface associated with the destination hostID.

FIG. 6B illustrates a method 650 of registering to send GATT notifications to a wireless device that includes a plurality of Bluetooth (BT) host-stacks in accordance with some embodiments. Method 650 may be performed by a controller (e.g., Bluetooth controller 320) or processor (e.g., application processor 216, etc.) in a wireless device (e.g., second BT device 106, etc.) that includes a GATT server.

With reference to FIGS. 1-6B, the controller may receive a GATT registration from a GATT client on the first wireless device in block 610. In some embodiments, the controller may receive the registration by determining that the GATT client wrote to a characteristic of the GATT server. In some embodiments, the controller may be configured to use the HCIConnectionId and the hostId as a unique GATT client-server pair to achieve GATT client-server uniqueness with respect to asynchronous connection-less (ACL) data. As a result, the controller may perform synchronization across GATT transactions, such as requests and responses (REQ/RSP), on a per [connId+hostId] basis (e.g., instead of [connId] or device address only), thereby avoiding synchronization requirements across the multiple host-stacks in the first wireless device.

In block 612, the controller may receive a source_host_id in a characteristic or request to receive notifications from the first wireless device. For example, the controller may receive the source_host_id by determining that GATT client wrote a hostId value to a characteristic of the GATT server.

In block 614, the controller may register the HCI-connection-handle and the source_host_id as a unique GATT-protocol endpoint so that all GATT notifications PDUs associated with the characteristic are sent on the notification characteristic with a destination host_id value set. The controller may set the destination host id value based on the source host id value received from the GATT client. By using a combination of the HCI connection handle, source_host_id, and destination host_id as a unique identifier, the controller may use the GATT protocol stack to manage multiple GATT connections at the same time. Only GATT transactions within unique-host-stack to unique-host-stack need to be sequential, thus and multiple GATT transactions may be performed simultaneously across different unique-host-stacks on the same device without the multiple GATT connections interfering with each other.

In block 616, the controller may send a GATT notification that includes the destination host id to the first wireless device. In some embodiments, the controller may send the GATT notification by writing to a characteristic and/or by informing the GATT client that notification information is available.

FIG. 6C illustrates a method 660 of using the generic attribute profile (GATT) protocol to communicate over multiple host controller interfaces (HCIs) on a wireless device that includes a plurality of Bluetooth (BT) host-stacks in accordance with some embodiments. Method 660 may be performed by a controller (e.g., Bluetooth controller 320) or processor (e.g., application processor 216, etc.) in a wireless device (e.g., first BT device 102, etc.).

With reference to FIGS. 1-6C, the controller may perform the operations discussed above with reference to blocks 602-608 of FIG. 6A in blocks 602-608. In block 662, the controller may identify the application registered for the notification. In block 664, the controller may forward the notification to the application.

FIGS. 6D and 6E illustrate methods 670, 680 of registering and receiving GATT notifications in accordance with some embodiments. Methods 670 and 680 may be performed by a controller (e.g., Bluetooth controller 320) or processor (e.g., application processor 216, etc.) in a wireless device (e.g., first BT device 102, etc.).

With reference to FIGS. 1-6D, a GATT client application operating on the first wireless device may send a GATT-characteristic notification registration to a GATT server/service in block 672. In block 674, the GATT server/service may identify the GATT service and the HostID (on the remote peer) associated with the characteristic. In block 672, the GATT server/service may include the HostID associated with the GATT service in the Tx Message (with 0 as default).

With reference to FIGS. 1-6E, a GATT server application may send an updated characteristic value for the notification in block 682. The GATT server/service on the host-stack may identify the remote peer HostID in block 684. The GATT server/service on the host-stack may include the source HostID (0 default) and destination HostID (0 default) in the message that is sent to the GATT client application in block 686.

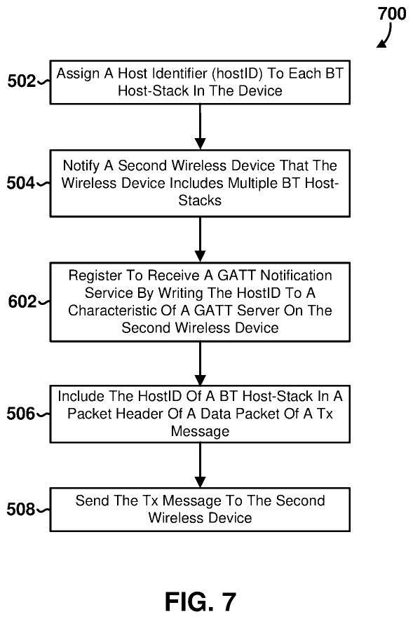

FIG. 7 illustrates a method 700 of communicating over multiple host controller interfaces (HCIs) on a first wireless device that includes a plurality of Bluetooth (BT) host-stacks in accordance with some embodiments. In particular, the method 700 may maintain a single logical link control and adaptation protocol (L2CAP) channel for radio frequency communication (RFCOMM) and/or generic attribute profile (GATT) to the second wireless device in accordance with some embodiments. The method 700 may be performed by a controller (e.g., Bluetooth controller 320) or processor (e.g., application processor 216, etc.) in a first wireless device (e.g., first BT device 102, etc.).

With reference to FIGS. 1-7, the controller may assign a host identifier (hostID) to each BT host-stack in the device in block 502 and notify a second wireless device (e.g., second BT device 106, etc.) that the first wireless device includes multiple BT host-stacks in block 504 as described.

In block 602, the controller may register to receive a GATT notification service by writing the hostID to a characteristic of a GATT server on the second wireless device. In block 506, the controller may include the hostID of a BT host-stack in a packet header of a data packet of a Tx message. In block 508, the controller may send the Tx message to the second wireless device.

Thus, in the example method 700 illustrated in FIG. 7, the controller of the first wireless device may maintain a single logical link control and adaptation protocol (L2CAP) channel for radio frequency communication (RFCOMM) and/or generic attribute profile (GATT) to the second wireless device. This embodiment may improve the efficiency of packet forwarding and other Bluetooth operations within the device, and maintain compliance with existing and future Bluetooth standards, all without consuming an excessive amount of device power or processing resources.

In some embodiments, methods of communicating over multiple HCIs on a wireless device that includes multiple BT host-stacks may include operations for service discovery, connecting to a service, and performing transmit (TX) and receive (RX) operations.

The discovery of services on a multi-host server may be implemented through the use of RFCOMM, GATT, etc. When both wireless devices in a client-server pair are configured in accordance with the various embodiments, the client device may request a list of services from the server with destination-host-id set to zero (default host-stack) and source-host-id identifying the correct host. The server may check to determine whether the client device is configured to support multiple BT hosts over multiple HCIs in accordance with some embodiments. If not, the server may send the client device a service list that includes services associated with the default stack (legacy protocol). If the client device is configured to support multiple BT hosts over multiple HCIs, the server may send a list of all services it has from all its host-stacks including the associated host-ID. The destination-host-id may be set based on the source-host-id that was received in the request. The client device may receive the response that includes the destination-host-ID and forward it along the correct HCI interface. The list of services may then be sent to the client's application (client app).

The operations for connecting to a service may include establishing a connection between two end-points (RFCOMM) or creating an association between a GATT-client and a GATT-server (GATT protocol is connectionless). The operations may include the client app operating on the client device invoking an API to connect to a service, and on-host stack client looking up the remote host-ID associated with the service to use as the destination-ID. If these “connect” operations are successful, the devices may cache the mapping {appId->remote_host_ID} on both the client-on-host and server-on-host (the remote-addr, rfcomm-DLCI's may be already cached and mapped to appId). This mapping stored in cache memory may allow a wireless device configured in accordance with various embodiments to set the appropriate values (source_host_ID, destination_host_id) associated with the service, with those values used for sending and receiving messages.

To transmit (Tx) a message from the client device to server, a local client app (Local-App) may call a host API. A local client host (Local-Host) may identify the remote host-ID as the destination. The local client host may set {Source-host-id, destination-host-id} in L2CID and transmit the message. A remote controller (Remote-Controller) may forward the message to the right host stack. A remote server (Remote-Server) may look up appID from info cached at service connect and forward the message to the correct software application (e.g., Local-App).

To receive (Rx) a message on the client device, a remote app (Remote-App) on remote device may invoke a remote-host-API to transmit the message. The remote host (Remote-Host) may look up the destination-host-ID (from the information cached at service connect). The remote host (or controller) may set the source_host ID and destination_host_ID (e.g., set {source_host_ID, destination_host_ID}) and transmit the message. A local controller (Local-Controller) may forward the message to the correct HCI interface based on destination_host_id of the message. The local controller (Local-Controller) may identify the correct local client app (Local-App) to forward the message to, and send the message to the identified local client app.

In some embodiments, the methods may include performing GATT notification registration (e.g., from GATT-server to GATT-client). An observer for a registered GATT characteristic notification on the GATT-server may include the GATT-client hostID. A GATT-client may invoke a GATT-host API to register for notification on a GATT characteristic (e.g., by writing to a characteristic). The GATT-client may then perform the operations discussed above to transmit (Tx) a message. The GATT-server may forward a write-characteristic request to the GATT-server-app along with the software object that encapsulates remote endpoint details. For example, in Android it is a software object of class BluetoothDevice. For ease of reference, some examples below may refer to the endpoint object as endpointObj. The endpointObj may include a remote-device-address and hostID of the client. The server-app may not know about the details of host-id. The GATT-server-app may cache the endpointObj as an “observer” for notifications associated with the characteristic.

For GATT notification receive (Rx), the GATT client end may receive a notification Rx similar to any other received notification. For GATT notification transmit (Tx), in response to determining that a characteristic on server-app has changed, the GATT-server-app may send updated {characteristic value, endpointObject} to the GATT-server. The GATT-server may identify the destination-host-ID from the endpointObject. The GATT-client may then perform the operations discussed above to transmit (Tx) a message.

Some embodiments may look up, identify or cache: (i) HostID's; (ii) {application_id->HostID}; (iii) {remote_service->Remote_host_ID}. This information may be used to discover a multi host server and connect to services on the client or server in order to successfully transmit and receive messages over an RFCOMM or GATT connection.

The methods 500, 550, 600, 650 and 700 may allow wireless devices to offload Bluetooth related functionality from the application processor to a lower-power processor, thereby allowing the high-speed application processor to be turned off to save power. For example, Bluetooth applications may leverage a Bluetooth stack running on the low-power processor instead of relying on the Bluetooth stack running on the high-speed application processor. As another example, in a smartwatch with a small battery, notification functionalities could be offloaded to the low-power processor to conserve energy.

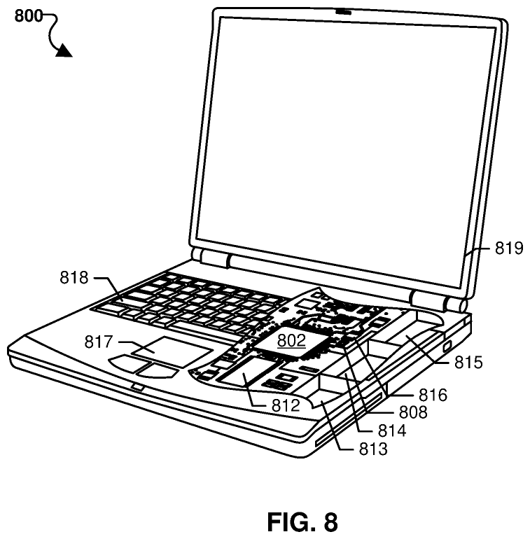

The various embodiments (including, but not limited to, embodiments described above with reference to FIGS. 1-7) may be implemented in a wide variety of wireless devices and computing systems include a laptop computer 800 including a Bluetooth transceiver, an example of which is illustrated in FIG. 8. With reference to FIGS. 1-8, a laptop computer may include a touchpad touch surface 817 that serves as the computer's pointing device, and thus may receive drag, scroll, and flick gestures similar to those implemented on computing devices equipped with a touch screen display and described above. A laptop computer 800 will typically include a processor 802 coupled to volatile memory 812 and a large capacity nonvolatile memory, such as a disk drive 813 of Flash memory. Additionally, the computer 800 may have one or more antenna 808 for sending and receiving electromagnetic radiation that may be connected to a wireless data link and/or cellular telephone transceiver 816 coupled to the processor 802. The computer 800 may also include a BT transceiver 814 implementing various embodiments. The computer 800 may also include a compact disc (CD) drive 815 coupled to the processor 802. The laptop computer 800 may include a touchpad 817, a keyboard 818, and a display 819 all coupled to the processor 802. Other configurations of the computing device may include a computer mouse or trackball coupled to the processor (e.g., via a Universal Serial Bus (USB) input) as are well known, which may also be used in conjunction with the various embodiments.

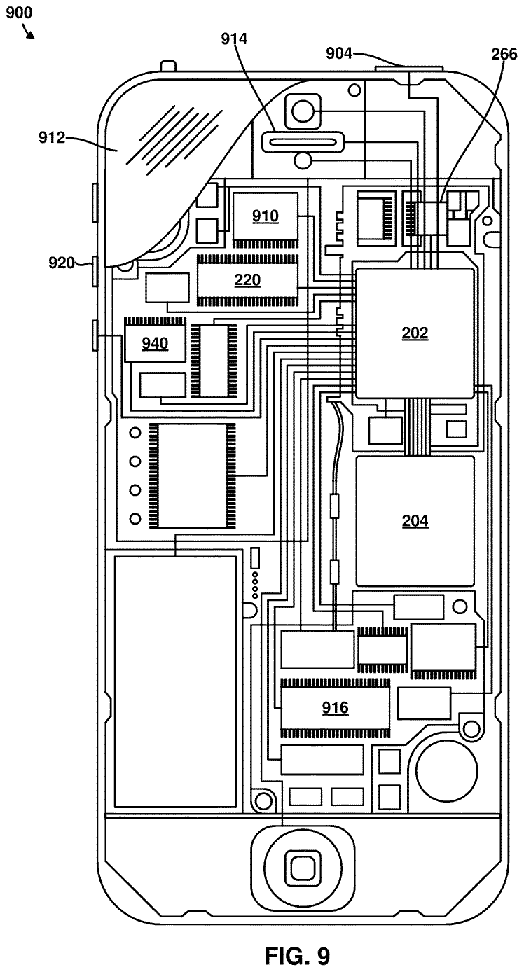

FIG. 9 is a component block diagram of a computing device 900 suitable for use with various embodiments. With reference to FIGS. 1-9, various embodiments may be implemented on a variety of computing devices 900 (e.g., 102, 200, 216, 400), an example of which is illustrated in FIG. 9 in the form of a smartphone. The computing device 900 may include a first circuitry 202 coupled to a second circuitry 204. The first and second SoCs 202, 204 may be coupled to internal memory 916, a display 912, and to a speaker 914. The first and second circuitries 202, 204 may also be coupled to at least one SIM 940 and/or a SIM interface that may store information supporting a first 5GNR subscription and a second 5GNR subscription, which support service on a 5G non-standalone (NSA) network.

The computing device 900 may include an antenna 904 for sending and receiving electromagnetic radiation that may be connected to a Buetooth transceiver 266 coupled to one or more processors in the first and/or second circuitries 202, 204. The computing device 900 may also include menu selection buttons or rocker switches 920 for receiving user inputs.

The computing device 900 also includes a sound encoding/decoding (CODEC) circuit 910, which digitizes sound received from a microphone into data packets suitable for wireless transmission and decodes received sound data packets to generate analog signals that are provided to the speaker to generate sound. Also, one or more of the processors in the first and second circuitries 202, 204, Bluetooth transceiver 266 and CODEC 910 may include a digital signal processor (DSP) circuit (not shown separately).

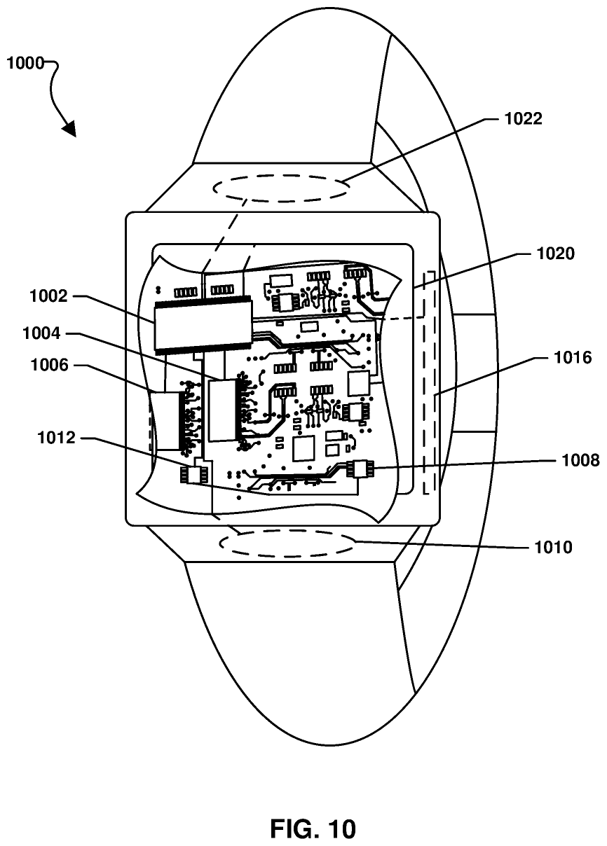

The various embodiments may be implemented within a variety of computing devices, such as a wearable computing device. FIG. 10 illustrates an example wearable computing device in the form of a smart watch 1000 according to some embodiments. A smart watch 1000 may include an SoC 1002 including two or more processors (e.g., application processor, low power processor) coupled to internal memories 1004 and 1006. Internal memories 1004, 1006 may be volatile or non-volatile memories, and may also be secure and/or encrypted memories, or unsecure and/or unencrypted memories, or any combination thereof. The SoC 1002 may also be coupled to a touchscreen display 1020, such as a resistive-sensing touchscreen, capacitive-sensing touchscreen infrared sensing touchscreen, or the like. Additionally, the smart watch 1000 may have one or more antenna 1008 for sending and receiving electromagnetic radiation that may be connected to one or more wireless data links 1012, such as one or more Bluetooth® transceivers that may be coupled to the SoC 1002. The smart watch 1000 may also include physical virtual buttons 1022 and 1010 for receiving user inputs as well as a slide sensor 1016 for receiving user inputs.

The touchscreen display 1020 may be coupled to a touchscreen interface module that is configured receive signals from the touchscreen display 1020 indicative of locations on the screen where a user's fingertip or a stylus is touching the surface and output to the SoC 1002 information regarding the coordinates of touch events. Further, the SoC 1002 may be configured with processor-executable instructions to correlate images presented on the touchscreen display 1020 with the location of touch events received from the touchscreen interface module in order to detect when a user has interacted with a graphical interface icon, such as a virtual button.

The SoC 1002 may be any programmable microprocessor, microcomputer or multiple processor chip or chips that can be configured by software instructions (applications) to perform a variety of functions, including the functions of the various embodiments. In some devices, multiple processors may be provided, such as one processor dedicated to wireless communication functions and one processor dedicated to running other applications. Typically, software applications may be stored in an internal memory before they are accessed and loaded into the SoC 1002. The SoC 1002 may include internal memory sufficient to store the application software instructions. In many devices the internal memory may be a volatile or nonvolatile memory, such as flash memory, or a mixture of both. For the purposes of this description, a general reference to memory refers to memory accessible by the SoC 1002 including internal memory or removable memory plugged into the mobile device and memory within the SoC 1002 itself.

The processors of the computer 800, the computing device 900, and the smart watch 1000 may be any programmable microprocessor, microcomputer, or multiple processor chip or chips that can be configured by software instructions (applications) to perform a variety of functions, including the functions of the various embodiments described. In some mobile devices, multiple processors may be provided, such as one processor within a first circuitry 204 dedicated to wireless communication functions and one processor within a second circuitry 202 dedicated to running other applications. Software applications may be stored in the memory 220, 258, 320, 916 before they are accessed and loaded into the processor. The processors may include internal memory sufficient to store the application software instructions.

Example 1: A method of communicating over multiple host controller interfaces (HCIs) on a first wireless device that includes a plurality of Bluetooth (BT) host-stacks, including assigning a host identifier (hostID) to each BT host-stack in the plurality of BT host-stacks, notifying a second wireless device that the first wireless device includes the plurality of BT host-stacks, including the hostID of a BT host-stack in a packet header of a data packet of a Tx message, and sending the Tx message to the second wireless device.

Example 2: The method of example 1, further including receiving a Rx message from the second wireless device, identifying a BT host-stack in the plurality of BT host-stacks or an HCI interface associated with a destination hostID included in the packet header of the received Rx message, and forwarding the received Rx message to the BT host-stack on the HCI interface associated with the destination hostID.

Example 3: The method of any of the examples 1 and 2, further including identifying an application-instance based on peer-id, source hostID, or remote hostID, and sending the Rx message from BT host-stack to a client application associated with the identified application-instance.

Example 4: The method of any of the examples 1-3, further including registering to receive generic attribute profile (GATT) notifications by writing the hostID to a server characteristic of a GATT server on the second wireless device.

Example 5: The method of example 4, further including receiving a GATT notification from the GATT server on the second wireless device, identifying a BT host-stack in the plurality of BT host-stacks or an HCI interface associated with a destination hostID included in the received GATT notification, and forwarding received GATT notification to the BT host-stack on the HCI interface associated with the destination hostID.

Example 6: The method of any of the examples 1-6, further including in the packet header of the data packet a value that identifies a processing unit of the first wireless device that includes the BT host-stack.

Example 7: The method of example 6, further including in the packet header of the data packet value that identifies an application-specific integrated circuit (ASIC), a digital signal processor (DSP), an audio digital signal processor (ADSP), or a microcontroller unit (MCU) that operates at a lower frequency than an application processor of the first wireless device.

Example 8: The method of any of the examples 1-7, in which including the hostID of the BT host-stack in the packet header of the data packet includes including the hostID in a logical link control and adaptation protocol (L2CAP) protocol data unit (PDU).

Example 9: The method of example 8, in which including the hostID in the L2CAP PDU includes generating a 16-bit L2CAP value that includes a source hostID and a destination hostID in most significant 4 bits of a L2CAP channel ID (L2CID) in the least significant 12 bits of the L2CAP.

Example 10: The method of any of the examples 1-9, further including storing a mapping of application-instance_id, peer-id, and remote hostID,

Example 11: The method of any of the examples 1-10, further including identifying a destination host ID based on an application-instance.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), Long Term Evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general Packet Radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A method of communicating over multiple host controller interfaces (HCIs) on a first wireless device that includes a plurality of Bluetooth (BT) host-stacks, comprising:
assigning a host identifier (hostID) to each BT host-stack in the plurality of BT host-stacks;
notifying a second wireless device that the first wireless device includes the plurality of BT host-stacks;
including the hostID of a BT host-stack in a packet header of a data packet of a transmit (Tx) message; and
sending the Tx message to the second wireless device.

2. The method of claim 1, further comprising:
receiving a receive (Rx) message from the second wireless device;
identifying a BT host-stack in the plurality of BT host-stacks or an HCI interface associated with a destination hostID included in the packet header of the received Rx message; and
forwarding the received Rx message to the BT host-stack on the HCI interface associated with the destination hostID.

3. The method of claim 2, further comprising:
identifying an application-instance based on peer-id, source hostID, or remote hostID; and
sending the Rx message from BT host-stack to a client application associated with the identified application-instance.

4. The method of claim 1, further comprising registering to receive generic attribute profile (GATT) notifications by writing the hostID to a server characteristic of a GATT server on the second wireless device.

5. The method of claim 4, further comprising:
receiving a GATT notification from the GATT server on the second wireless device;
identifying a BT host-stack in the plurality of BT host-stacks or an HCI interface associated with a destination hostID included in the received GATT notification; and
forwarding received GATT notification to the BT host-stack on the HCI interface associated with the destination hostID.

6. The method of claim 1, further comprising including in the packet header of the data packet a value that identifies a processing unit of the first wireless device that includes the BT host-stack in.

7. The method of claim 6, further comprising including in the packet header of the data packet a value that identifies an application-specific integrated circuit (ASIC), a digital signal processor (DSP), an audio digital signal processor (ADSP), or a microcontroller unit (MCU) that operates at a lower frequency than an application processor of the first wireless device.

8. The method of claim 1, wherein including the hostID of the BT host-stack in the packet header of the data packet comprises including the hostID in a logical link control and adaptation protocol (L2CAP) protocol data unit (PDU).

9. The method of claim 8, wherein including the hostID in the L2CAP PDU comprises generating a 16-bit L2CAP value that includes a source hostID and a destination hostID in most significant 4 bits of a L2CAP channel ID (L2CID) in the least significant 12 bits of the L2CAP.

10. The method of claim 1, further comprising storing a mapping of application-instance_id, peer-id, and remote hostID.

11. The method of claim 1, further comprising identifying a destination host ID based on an application-instance.

12. A wireless device, comprising:
a processor configured to:
assign a host identifier (hostID) to each of a plurality of Bluetooth (BT) host-stack;
notify a second wireless device that the wireless device includes the plurality of BT host-stacks;
include the hostID of a BT host-stack in a packet header of a data packet of a transmit (Tx) message; and
send the Tx message to the second wireless device.

13. The wireless device of claim 12, wherein the processor is further configured to:
receive a receive (Rx) message from the second wireless device;
identify a BT host-stack in the plurality of BT host-stacks or an HCI interface associated with a destination hostID included in the packet header of the received Rx message; and
forward the received Rx message to the BT host-stack on the HCI interface associated with the destination hostID.

14. The wireless device of claim 13, wherein the processor is further configured to:
identify an application-instance based on peer-id, source hostID, or remote hostID; and
send the Rx message from BT host-stack to a client application associated with the identified application-instance.

15. The wireless device of claim 12, wherein the processor is further configured to register to receive generic attribute profile (GATT) notifications by writing the hostID to a server characteristic of a GATT server on the second wireless device.

16. The wireless device of claim 15, wherein the processor is further configured to:
receive a GATT notification from the GATT server on the second wireless device;
identify a BT host-stack in the plurality of BT host-stacks or an HCI interface associated with a destination hostID included in the received GATT notification; and
forward received GATT notification to the BT host-stack on the HCI interface associated with the destination hostID.

17. The wireless device of claim 12, wherein the processor is further configured to include in the packet header of the data packet a value that identifies a processing unit of the wireless device that includes the BT host-stack.

18. The wireless device of claim 17, wherein the processor is further configured to include in the packet header a value that identifies an application-specific integrated circuit (ASIC), a digital signal processor (DSP), an audio digital signal processor (ADSP), or a microcontroller unit (MCU) that operates at a lower frequency than an application processor of the wireless device.

19. The wireless device of claim 12, wherein the processor is further configured to include the hostID of the BT host-stack comprises including the hostID in a logical link control and adaptation protocol (L2CAP) protocol data unit (PDU) in the packet header of the data packet.

20-22. (canceled)

23. A wireless device comprising:
means for assigning a host identifier (hostID) to each of a plurality of Bluetooth (BT) host-stack;
means for notifying a second wireless device that the wireless device includes the plurality of BT host-stacks;
means for including the hostID of a BT host-stack in a packet header of a data packet of a transmit (Tx) message; and
means for sending the Tx message to the second wireless device.

24-30. (canceled)
